(19) United States
(12) Patent Application Publication
(10) Pub. No.: US 2008/0183851 A1
(43) Pub. Date: Jul. 31, 2008

(54) Apparatus and Method Pertaining to Management of On-Line Certificate Status Protocol Responses in a Cache

(75) Inventors: Devarajan Puthupparambil, Mt. Prospect, IL (US); J. Schneider, Grayslake, IL (US)

Correspondence Address: UTSTARCOM, INC. / FETF, 120 S. LASALLE STREET, SUITE 1600, CHICAGO, IL, 60603-3406, US

(73) Assignee: UTSTARCOM, INC., Alameda, CA (US)

(21) Appl. No.: 11/668,804

(22) Filed: Jan. 30, 2007

(51) Int. Cl. G06F 15/16

(52) U.S. Cl. 709/223

(57) ABSTRACT

Upon receiving (101) an OCSP response as corresponds to a remote-location Internet Protocol-based authorization terminal to use with respect to a secure connection with the remote-location Internet Protocol-based authorization terminal, one automatically caches (102) the OCSP response in a cache and thereby renders the OCSP response available to use when facilitating a subsequent secure connection with the remote-location Internet Protocol-based authorization terminal. When the cache is of insufficient size to contain OCSP responses for a corresponding population of serviced remote-location Internet Protocol-based authorization terminals, this cache can be automatically managed (103) to tend to retain OCSP responses for remote-location Internet Protocol-based authorization terminals that are relatively likelier to have a near-term need for a secure connection while tending to remove OCSP responses for remote-location Internet Protocol-based authorization terminals that are relatively less likely to have a near-term need for the secure connection.

### TECHNICAL FIELD

This invention relates generally to secure communications with remote-location Internet Protocol-based authorization terminals.

### BACKGROUND

Remote-location Internet Protocol-based authorization terminals of various kinds, such as but not limited to so-called point-of-service (or point-of-sale) (POS) terminals, automatic teller machines (ATM's), and so forth are known in the art. As used herein, “remote location” will be understood to typically refer to physical remoteness where the platform in question is separated by many miles (sometimes hundreds or even thousands of miles) from a corresponding authorization host. In an illustrative example, this might comprise the essentially ubiquitous point-of-sale credit card transaction authorization terminals as are employed by nearly all retail establishments in many countries.

Such remote-location Internet Protocol-based authorization terminals are typically configured to establish a connection to an authorization host on an as-needed basis using, at least in part, an Internet Protocol. In a typical application scenario these connections comprise secure connections (such as a secure sockets layer (SSL)-based connection) that provides for conversion of at least some of the communication payload to be conveyed to an encrypted form to thereby discourage unauthorized monitoring and usage.

The methodology and protocol to employ when establishing such a secure connection is known in the art. By one approach two layers serve to facilitate the well known SSL protocol. A lowest layer (typically layered on top of some transport protocol of choice such as the transport control protocol (TCP)) carries the SSL record protocol. The latter serves, in turn, to encapsulate various higher level protocols. One such encapsulated protocol, the SSL handshake protocol, permits a server and a client to authenticate each other and to negotiate an encryption algorithm and cryptographic keys before permitting the transmission or reception of any data payloads. The SSL handshake protocol facilitates client verification by use of client certificate verification.

In many cases such verification, in turn, relies upon the on-line certificate status protocol (OCSP). Such verification typically provides for transmitting OCSP requests to OCSP Responders regarding the certificate status of the client. Each such request is usually digitally signed and the corresponding OCSP response will then indicate whether the client certificate is currently valid/active.

In some cases, the time required to establish a secure connection can be relatively time consuming (particularly as compared to the overall time required to otherwise effect a given transaction authorization request). This time may or may not be particularly noticeable to a platform user but can, when viewed in the aggregate over many tens of thousands of such platforms, represent considerable network overhead. Part of this temporal overhead relates to the sending of an OCSP request as described above for each and every SSL session. Repetition of such certificate information forwarding, signature decryption, and certificate status checking can contribute greatly to such temporal loading.

### BRIEF DESCRIPTION OF THE DRAWINGS

The above needs are at least partially met through provision of the apparatus and method pertaining to management of on-line certificate status protocol responses in a cache described in the following detailed description, particularly when studied in conjunction with the drawings, wherein:

FIG. 1 comprises a flow diagram as configured in accordance with various embodiments of the invention;

FIG. 2 comprises a schematic view of a memory cache as configured in accordance with various embodiments of the invention;

FIG. 3 comprises a schematic view of a memory cache as configured in accordance with various embodiments of the invention;

FIG. 4 comprises a schematic view of a memory cache as configured in accordance with various embodiments of the invention;

FIG. 5 comprises a schematic view of a memory cache as configured in accordance with various embodiments of the invention;

FIG. 6 comprises a schematic view of a memory cache as configured in accordance with various embodiments of the invention; and

FIG. 7 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a platform such as a transaction data processing node, upon receiving an OCSP response as corresponds to a remote-location Internet Protocol-based authorization terminal to use with respect to a secure connection with the remote-location Internet Protocol-based authorization terminal can automatically cache the OCSP response in a cache and thereby render the OCSP response available to use when facilitating a subsequent secure connection with the remote-location Internet Protocol-based authorization terminal. When the cache is of insufficient size to contain OCSP responses for each member of a corresponding population of serviced remote-location Internet Protocol-based authorization terminals, this cache can be automatically managed to tend to retain OCSP responses for remote-location Internet Protocol-based authorization terminals that are relatively likelier to have a near-term need for a secure connection while tending to remove OCSP responses for remote-location Internet Protocol-based authorization terminals that are relatively less likely to have a near-term need for the secure connection.

By one approach, such cache management can comprise, at least in part, tending to remove OCSP responses for remote-location Internet Protocol-based authorization terminals that have not required use of an OCSP response for at least a predetermined period of time and/or that have required use of an OCSP response fewer times relative to others of the remote-location Internet Protocol-based authorization terminals. If desired, these teachings will also optionally accommodate determining that a given cached OCSP response is (or is about to become) stale and then determining to automatically refresh that cached OCSP response. Such a refreshed OCSP response can then be automatically cached and managed as noted above.

So configured, these teachings permit cached OCSP responses to be employed for a plurality of secure SSL sessions for the busiest remote-location Internet Protocol-based authorization terminals. This, in turn, can greatly aid in reducing temporal overhead requirements for a corresponding system. Those skilled in the art will appreciate that these teachings are readily implemented at moderate cost and represent a readily scalable process that can be employed with a relatively large number of remote-location Internet Protocol-based authorization terminals.

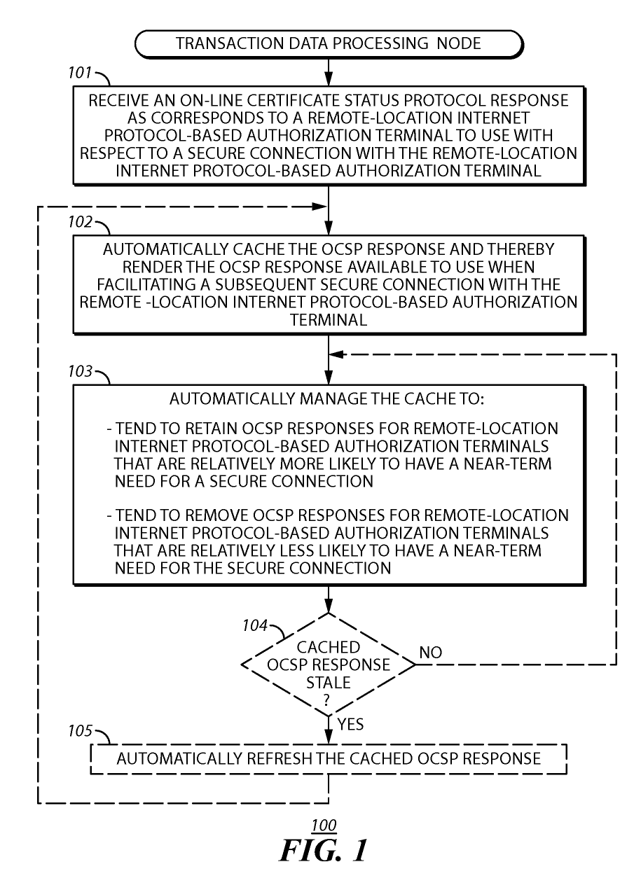

These and other benefits may become clearer upon making a thorough review and study of the following detailed description. Referring now to the drawings, and in particular to FIG. 1, a process 100 suitable for use by a transaction data processing node (such as, but not necessarily limited to, a packet switching node as is known in the art) will first be described.

Pursuant to this process, the transaction data processing node receives 101 an on-line certificate status protocol (OCSP) response (comprising, for example, a so-called active response to indicate an active status for a corresponding certificate) as corresponds to a remote-location Internet Protocol-based authorization terminal to use with respect to a secure connection with that remote-location Internet Protocol-based authorization terminal. This secure connection can comprise, for example, a secure sockets layer (SSL) connection as is known in the art. Reception of this information can correspond, for example, to a given secure communication as has been initiated by the remote-location Internet Protocol-based authorization terminal. To this extent, if desired, this step of receiving 101 such information can squarely accord with prior art practice in this regard.

Then, however, in response to having received 101 this OCSP response, the transaction data processing node then automatically caches 102 the OCSP response in a cache. In a typical embodiment, this cache will be of insufficient size to contain OCSP responses for all members of a corresponding population of serviced remote-location Internet Protocol-based authorization terminals. That said, this cache may be of a particular size and capacity as will meet the needs and/or opportunities as tend to characterize a given application setting. Those skilled in the art will appreciate that such caching now renders the cached OCSP response available to use when facilitating a subsequent secure connection with this same remote-location Internet Protocol-based authorization terminal. In particular, such subsequent communications can be supported without requiring the previously mentioned activities and exchanges to re-establish the desired verified status. This, in turn, can save considerable time.

As noted, however, the cache is of insufficient capacity to contain and maintain such information for every candidate remote-location Internet Protocol-based authorization terminal in a serviced population. Accordingly, this process 100 then also provides for automatically managing 103 this cache to both tend to retain OCSP responses for certain terminals while tending to remove OCSP responses for other terminals. More particularly, this can comprise, in part, tending to retain OCSP responses for remote-location Internet Protocol-based authorization terminals that are relatively likelier to have a near-term need for a secure connection and to remove OCSP responses for remote-location Internet Protocol-based authorization terminals that are relatively less likely to have a near-term need for a secure connection.

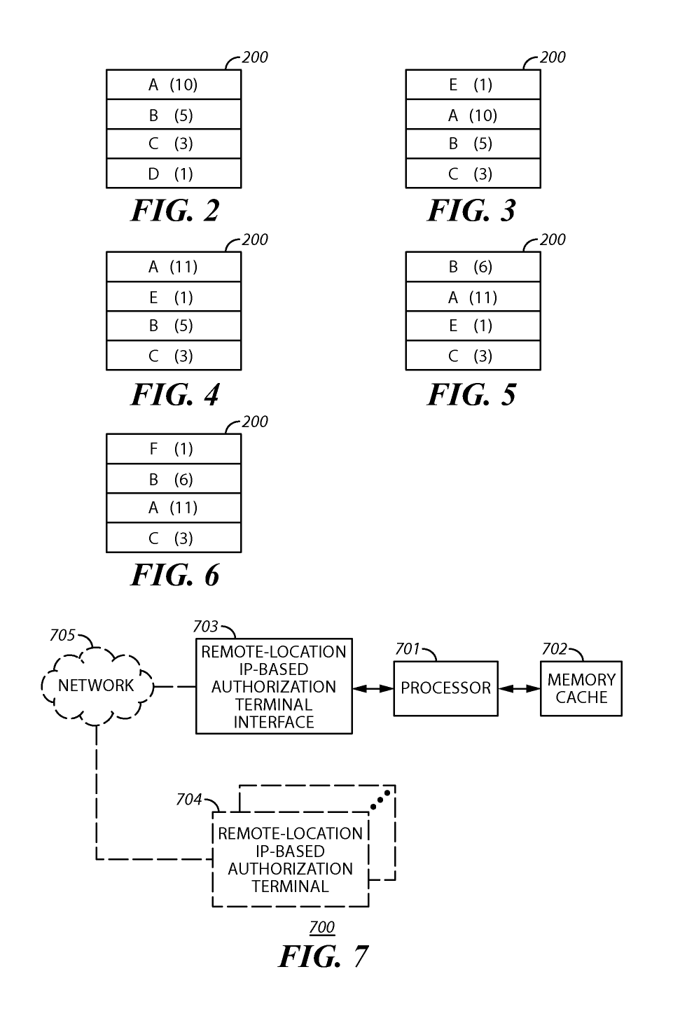

There are various bases upon which such management can be predicated. By one approach, for example, such retention and culling behaviors can be based, at least in part, upon removing OCSP responses for remote-location Internet Protocol-based authorization terminals that have required use of an OCSP response fewer times relative to others of the remote-location Internet Protocol-based authorization terminals. Referring now to FIGS. 2 through 6, some illustrative examples in this regard will be offered. These examples presume, for the sake of clarity and simplicity, that the memory cache has only a sufficient capacity to retain four such OCSP responses. Those skilled in the art will understand and recognize that these examples serve an illustrative purpose only and are not offered as an exhaustive explanation in these regards. In particular, in a real-world application, the size of such a cache is more likely to accommodate hundreds if not thousands of such responses.

With reference to FIG. 2, the memory cache 200 initially contains (for purposes of these examples) four OCSP responses for each of a remote-location Internet Protocol-based authorization terminal A, a remote-location Internet Protocol-based authorization terminal B, a remote-location Internet Protocol-based authorization terminal C, and a remote-location Internet Protocol-based authorization terminal D. In this example, the OCSP response information for each such user also includes information reflecting how many times that particular terminal has required use of an OCSP response (within, say, some predetermined period of time such as one minute, one hour, one day, and so forth as desired). Accordingly, in this example, remote-location Internet Protocol-based authorization terminal A has required use of an OCSP response a total of ten times while remote-location Internet Protocol-based authorization terminal B has required usage of an OCSP response a total of five times.

Referring now to both FIGS. 2 and 3, a fifth remote-location Internet Protocol-based authorization terminal denoted as E has experienced a first use of an OCSP response. As per these teachings, that OCSP response is cached in this memory 200. As this memory 200 can only contain a maximum of four such OCSP responses (as noted above), however, one of the previously cached OCSP responses must now be removed. In this case, the previously cached OCSP response for remote-location Internet Protocol-based authorization terminal D has been removed from the cache 200. In this particular case, the removal of this particular OCSP response is based, at least in part, upon the fact that this particular terminal exhibits a least amount of activity over a longest period of time as compared to other cached responses.

Referring now to both FIGS. 3 and 4, the cached OCSP response for remote-location Internet Protocol-based authorization terminal A is again utilized in a corresponding transaction. This event, in turn, causes the cached information for remote-location Internet Protocol-based authorization terminal A to be updated to increment its count from a value of ten to a value of 11 and also to reflect the current nature of the transaction activity itself (denoted here by advancing remote-location Internet Protocol-based authorization terminal A's location in the cache 200 while demoting remote-location Internet Protocol-based authorization terminal E's position in that cache 200). By this approach the contents of the cache 200 are tending to reflect both the number of times that a given remote-location Internet Protocol-based authorization terminal makes use of the cached contents as well as the relative age of at least the most recent activity in this regard.

Referring now to both FIGS. 4 and 5, and somewhat similar to the previous example, remote-location Internet Protocol-based authorization terminal B now makes use of its cached OCSP response and hence the cached information for remote-location Internet Protocol-based authorization terminal B is both incremented with respect to its count and advanced to reflect its relative temporal standing. Referring now to both FIGS. 5 and 6, a sixth remote-location Internet Protocol-based authorization terminal denoted as “F” now gives rise to a first use of a corresponding OCSP response. As per these teachings and as exemplified above with remote-location Internet Protocol-based authorization terminal E, this OCSP response to now cached as shown in FIG. 6. Again, as before, a previously cached OCSP response must now be removed. In this example, remote-location Internet Protocol-based authorization terminal C exhibits less current activity than remote-location Internet Protocol-based authorization terminal E, but remote-location Internet Protocol-based authorization terminal E exhibits considerably less activity than remote-location Internet Protocol-based authorization terminal C. In this particular example, remote-location Internet Protocol-based authorization terminal C is favored and remote-location Internet Protocol-based authorization terminal E is removed.

As demonstrated above, this management of the cache can be based, at least in part, upon comparing relative usage of the cached OCSP responses and/or upon comparing relative times of usage of these cached OCSP responses. By one approach, for example, a next cached OCSP response removed can comprise a response that has not seen required use for at least a predetermined period of time. To aid with the making of such comparative determinations, if desired, the cached information as pertains to given OCSP responses can include a time stamp, an incrementing or decrementing count, and so forth. Those skilled in the art will recognize and understand that other criteria of interest can be utilized as well to inform such cache management and that these present teachings are not limited to the specific examples set forth herein.

Referring again to FIG. 1, it is possible that a given cached OCSP response can become unduly aged without being deleted from the cache through the management process described above. If desired, this process 100 will accommodate determining 104 that a given cached OCSP response has become stale and then determining whether to automatically refresh that cached OCSP response.

Determining that a given cached OCSP response is stale can comprise, by one approach, determining that a predetermined effective window of usage (such as, for example, ten seconds, 30 seconds, one minute, 15 minutes, and so forth) for the cached OCSP response is at least about to expire. Determining whether to automatically refresh a stale cached OCSP response can be based, if desired, upon a determination of how likely a refreshed OCSP response for this corresponding remote-location Internet Protocol-based authorization terminal is going to be needed for a near-term secure connection. Such a determination can of course be based upon any of a wide variety of objective and subjective criteria of choice and can further reflect the various needs and/or opportunities as correspond to a given application setting.

Upon determining to automatically refresh such content, this process 100 will optionally further accommodate automatically refreshing 105 the cached OCSP response that can in turn be cached and managed in accordance with these teachings as set forth herein. Refreshing an OCSP response, of course, can comprise a time-consuming activity as noted above. Accordingly, if desired, this process 100 will accommodate automatically refreshing 104 a cached OCSP response as a background task. This will be understood by those skilled in the art to mean that the computational activities in support of establishing a new OCSP response are conducted with a reduced priority in comparison to the real time needs and functionality of the transaction data processing node. To illustrate, effecting this step can be handled in a piecemeal fashion in between responding to current requests for transaction authorization connections from other remote-location Internet Protocol-based authorization terminals.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 7, an illustrative approach to such a platform will now be provided.

The illustrated exemplary transaction data processing node comprises a processor 701 that operably couples to a memory cache 702 and a remote-location Internet Protocol-based authorization terminal interface 703. The latter, in turn, can be configured and arranged to couple to one or more remote-location Internet Protocol-based authorization terminals 704 via, for example, a network 705 of choice such as but not limited to an extranet such as the Internet. The memory cache 702 can comprise any centralized or distributed memory platform of choice and can comprise a local and/or remote resource utilizing any desired and/or available memory architecture and technology. The processor can comprise a dedicated purpose and/or a partially or wholly programmable platform that is configured and arranged (via, for example, corresponding programming) to effect selected steps as are set forth herein. This can include, as desired, receiving the aforementioned OCSP responses, caching those responses in the memory cache 702, and managing the corresponding memory cache 702 to tend to retain certain responses while tending to remove others. This can also include, if desired and as described above, determining when cached OCSP responses are (or are about to become) stale, determining whether to refresh a stale OCSP response, and caching refreshed OCSP responses.

Those skilled in the art will recognize and understand that such an apparatus 700 may be comprised of a plurality of physically distinct elements as is suggested by the illustration shown in FIG. 7. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, those skilled in the art will recognize and appreciate that considerable savings in time can be gained with little corresponding infrastructure overhead or expense. These teachings provide considerable leveraged benefit that derives from a body of pre-existing activity and those skilled in the art will recognize and understand that these teachings are readily scaled to accommodate a widely varying number of serviced remote-location Internet Protocol-based authorization terminals.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a transaction data processing node:
receiving an on-line certificate status protocol (OCSP) response as corresponds to a remote-location Internet Protocol-based authorization terminal to use with respect to a secure connection with the remote-location Internet Protocol-based authorization terminal;
automatically caching the OCSP response in a cache and thereby rendering the OCSP response available to use when facilitating a subsequent secure connection with the remote-location Internet Protocol-based authorization terminal;
automatically managing the cache to:
tend to retain OCSP responses for remote-location Internet Protocol-based authorization terminals that are relatively likelier to have a near-term need for a secure connection; and
to tend to remove OCSP responses for remote-location Internet Protocol-based authorization terminals that are relatively less likely to have a near-term need for the secure connection.

2. The method of claim 1 wherein the secure connection comprises a secure sockets layer (SSL) connection.

3. The method of claim 1 wherein the OCSP response comprises an “active” response.

4. The method of claim 1 wherein the cache is of insufficient size to contain OCSP responses for a corresponding population of serviced remote-location Internet Protocol-based authorization terminals.

5. The method of claim 1 wherein automatically managing the cache to tend to remove OCSP responses for remote-location Internet Protocol-based authorization terminals that are relatively less likely to have a near-term need for the secure connection comprises removing OCSP responses for remote-location Internet Protocol-based authorization terminals that have not required use of an OCSP response for at least a predetermined period of time.

6. The method of claim 1 wherein automatically managing the cache to tend to remove OCSP responses for remote-location Internet Protocol-based authorization terminals that are relatively less likely to have a near-term need for the secure connection comprises removing OCSP responses for remote-location Internet Protocol-based authorization terminals that have required use of an OCSP response fewer times relative to others of the remote-location Internet Protocol-based authorization terminals.

7. The method of claim 1 further comprising:
determining that a cached OCSP response is stale;
determining to automatically refresh the cached OCSP response.

8. The method of claim 7 wherein determining that a cached OCSP response is stale comprises determining that a predetermined effective window of usage for the cached OSCP response is at least about to expire.

9. The method of claim 7 wherein determining to automatically refresh the cached OCSP response comprises determining whether to automatically refresh the cached OCSP response as a function, at least in part, of how likely a refreshed OCSP response for this corresponding remote-location Internet Protocol-based authorization terminal is going to be needed for a near-term secure connection.

10. The method of claim 7 further comprising:
automatically refreshing the cached OCSP response to provide a refreshed OCSP response.

11. The method of claim 10 wherein automatically refreshing the cached OCSP response comprises automatically refreshing the cached OCSP response as a background task.

12. The method of claim 10 further comprising:
automatically caching the refreshed OCSP response in the cache and thereby rendering the refreshed OCSP response available to use when facilitating a subsequent secure connection with the remote-location Internet Protocol-based authorization terminal.

13. A transaction data processing node comprising:
a remote-location Internet Protocol-based authorization terminal interface;
a memory cache;
a processor operably coupled to the remote-location Internet Protocol-based authorization terminal interface and the memory cache and being configured and arranged to:
receive an on-line certificate status protocol (OCSP) response as corresponds to a remote-location Internet Protocol-based authorization terminal to use with respect to a secure connection with the remote-location Internet Protocol-based authorization terminal;
automatically cache the OCSP response in the cache and thereby render the OCSP response available to use when facilitating a subsequent secure connection with the remote-location Internet Protocol-based authorization terminal;
automatically manage the cache to:
tend to retain OCSP responses for remote-location Internet Protocol-based authorization terminals that are relatively likelier to have a near-term need for a secure connection; and
to tend to remove OCSP responses for remote-location Internet Protocol-based authorization terminals that are relatively less likely to have a near-term need for the secure connection.

14. The transaction data processing node of claim 13 wherein the secure connection comprises a secure sockets layer (SSL) connection.

15. The transaction data processing node of claim 13 wherein the OCSP response comprises an “active” response.

16. The transaction data processing node of claim 13 wherein the cache is of insufficient size to contain OCSP responses for a corresponding population of serviced remote-location Internet Protocol-based authorization terminals.

17. The transaction data processing node of claim 13 wherein the processor is further configured and arranged to automatically manage the cache to tend to remove OCSP responses for remote-location Internet Protocol-based authorization terminals that are relatively less likely to have a near-term need for the secure connection by removing OCSP responses for remote-location Internet Protocol-based authorization terminals that have not required use of an OCSP response for at least a predetermined period of time.

18. The transaction data processing node of claim 13 wherein the processor is further configured and arranged to automatically manage the cache to tend to remove OCSP responses for remote-location Internet Protocol-based authorization terminals that are relatively less likely to have a near-term need for the secure connection by removing OCSP responses for remote-location Internet Protocol-based authorization terminals that have required use of an OCSP response fewer times relative to others of the remote-location Internet Protocol-based authorization terminals.

19. The transaction data processing node of claim 13 wherein the processor is further configured and arranged to:
determine that a cached OCSP response is stale;
determine to automatically refresh the cached OCSP response.

20. The transaction data processing node of claim 19 wherein the processor is further configured and arranged to determine that a cached OCSP response is stale by determining that a predetermined effective window of usage for the cached OSCP response is at least about to expire.

21. The transaction data processing node of claim 19 wherein the processor is further configured and arranged to determine to automatically refresh the cached OCSP response by determining whether to automatically refresh the cached OCSP response as a function, at least in part, of how likely a refreshed OCSP response for this corresponding remote-location Internet Protocol-based authorization terminal is going to be needed for a near-term secure connection.

22. The transaction data processing node of claim 19 wherein the processor is further configured and arranged to:
automatically refresh the cached OCSP response to provide a refreshed OCSP response.

23. The transaction data processing node of claim 22 wherein the processor is further configured and arranged to automatically refresh the cached OCSP response by automatically refreshing the cached OCSP response as a background task.

24. The transaction data processing node of claim 22 wherein the processor is further configured and arranged to:
automatically cache the refreshed OCSP response in the cache and thereby render the refreshed OCSP response available to use when facilitating a subsequent secure connection with the remote-location Internet Protocol-based authorization terminal.
